(19) United States
(12) Patent Application Publication
(10) Pub. No.: US 2026/0026493 A1
(43) Pub. Date: Jan. 29, 2026

(54) SECURE BAIT BOX WITH SECURE BAIT AND ATTACHMENT SYSTEM

(71) Applicant: Trapmaster Technologies, LLC, New York, NY (US)

(72) Inventors: Chayim Kirschenbaum, Bergenfield, NJ (US); Barry Weiss, Staten Island, NY (US); Marc Blumenfrucht, New York, NY (US); Jeffrey Kazan, Staten Island, NY (US)

(73) Assignee: Trapmaster Technologies, LLC, New York, NY (US)

(21) Appl. No.: 19/278,676

(22) Filed: Jul. 23, 2025

Related U.S. Application Data
(60) Provisional application No. 63/674,620, filed on Jul. 23, 2024.
(60) Provisional application No. 63/766,239, filed on Mar. 3, 2025.

(51) Int. Cl. A01M 23/16; A01M 25/00

(52) U.S. Cl. CPC A01M 23/16; A01M 25/004

(57) ABSTRACT

A secure bait box for pest removal is disclosed. Such a box comprises: a base including: a bottom surface, a sidewall disposed along, and extending from, a perimeter of the bottom surface, an interior space defined by the bottom surface and the sidewall; an entrance aperture disposed within the sidewall; a lid affixed to the sidewall; one or more locks disposed on the base for reversibly securing the lid to the base; and a bait cartridge reversibly coupled to the base, the base cartridge including: a cartridge base able to secure a first bait, and a crossbar coupled to the cartridge base, the crossbar able to secure a second bait.

### CROSS REFERENCE TO RELATED APPLICATIONS

The present application claims the benefit of U.S. Provisional Patent Application Nos. 63/674,620 for SECURE BAIT BOX WITH SECURE BAIT AND ATTACHMENT SYSTEM, filed Jul. 23, 2024, and 63/766,239 for SECURE BAIT BOX WITH SECURE BAIT AND ATTACHMENT SYSTEM, filed Mar. 3, 2025, the entire contents of which are incorporated herein by reference.

### FIELD OF THE DISCLOSURE

The present disclosure is directed to an animal bait trap securing system. More specifically, the present disclosure is directed to a system for securely attaching a bait trap to various planar surfaces.

### INTRODUCTION

Previous approaches to bait boxes have typically involved simple designs with either nothing securing them to surfaces or permanently fixing them to a surface making them difficult to replace. These conventional bait boxes often lack robust security features, making them susceptible to tampering or theft by unauthorized individuals or wildlife. Additionally, the securing mechanisms on these traditional bait boxes may be prone to wear and tear over time, leading to potential failures in securing the bait box.

Due to bait boxes often containing toxic contents, such as rodent poison, properly securing a bait box to a surface is crucial in ensuring the bait box is not stolen or moved where the contents could then come into contact with an undesirable target. That said, the need to relocate a bait box can arise in instances where a rodent infestation has moved to a different location on a building or street.

Furthermore, conventional bait boxes are generally designed to accommodate only a single type of poison. Specifically, such existing bait boxes typically utilize either a solid or a liquid poison exclusively and do not incorporate both solid and liquid poisons within the same system. Additionally, the aforementioned conventional bait boxes do not presently enable users to interchange bait while said bait is secured to an external surface.

Thus, it is desirable to have a bait box which can be securely attached to a surface, while being able to be relocated should the need arise.

### SUMMARY

According to an aspect of the present disclosure, a secure bait box for pest removal may be provided. The secure bait box may include a base having a bottom surface, a sidewall disposed along and extending from a perimeter of the bottom surface, and an interior space defined by the bottom surface and the sidewall. The base may also feature an entrance aperture disposed within the sidewall. The secure bait box may further include a lid affixed to the sidewall, one or more locks disposed on the base for reversibly securing the lid to the base, and a bait cartridge reversibly coupled to the base. The bait cartridge may be comprised of a cartridge base able to secure a first bait, and a crossbar coupled to the cartridge base, the crossbar able to secure a second bait.

According to other aspects of the present disclosure, the secure bait box may include one or more of the following features. The first bait may be a solid bait. The second bait may be a solid bait. The secure bait box may further include a liquid dispenser including one or more liquid dispensing tubes. The second bait may be a liquid bait contained within the liquid dispenser. The lid may be hingedly affixed to the base. The secure bait box may further include one or more securing interfaces integrated into the base. The one or more securing interfaces may interface with one or more securing members to secure the base to an external surface. The one or more securing interfaces may be integrated into the sidewall, the bottom surface, or both the sidewall and the bottom surface. The secure bait box may further include a door hingedly affixed to the sidewall and covering the entrance aperture.

According to another aspect of the present disclosure, a secure bait box for pest removal is provided. The secure bait box may include a base having a bottom surface, a sidewall disposed along and extending from a perimeter of the bottom surface, and an interior space defined by the bottom surface and the sidewall. The interior space may feature a first compartment able to hold a first bait, a second compartment able to hold a second bait, and a third compartment able to hold a third bait. The base may include an entrance aperture for entry into the interior space disposed within the sidewall. The secure bait box may also feature a lid affixed to the sidewall, and one or more locks disposed on the base for reversibly securing the lid to the base.

According to other aspects of the present disclosure, the secure bait box may include one or more of the following features. The secure bait box may further include one or more securing interfaces integrated into the sidewall. The secure bait box may further include one or more securing interfaces integrated into the bottom surface. The secure bait box may further include one or more securing interfaces integrated into both the sidewall and the bottom surface. The secure bait box may further include a door hingedly affixed to the sidewall and covering the entrance aperture. The third compartment may include at least one magnet. The lid may be hingedly affixed to the base. The lid and the base may be constructed from injection-molded plastic.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

The incorporated drawings, which are incorporated in and constitute a part of this specification exemplify the aspects of the present disclosure and, together with the description, explain and illustrate principles of this disclosure.

FIG. 1 illustrates an embodiment of a bait box in a closed configuration according to various aspects of the present disclosure.

FIG. 2 illustrates an embodiment of the bait box according to various aspects of the present disclosure.

FIG. 3 illustrates a method for using embodiments of the bait box according to various aspects of the present disclosure.

FIG. 4 illustrates an embodiment of a bait box in a closed configuration in accordance with various aspects of the present disclosure.

FIG. 5 illustrates an embodiment of the bait box according to various aspects of the present disclosure.

FIG. 6 illustrates an embodiment of the bait box in an open configuration according to various aspects of the present disclosure.

FIG. 7 illustrates an embodiment of the bait box according to various aspects of the present disclosure.

FIG. 8 illustrates an embodiment of a weighted base.

FIG. 9 illustrates an embodiment of the bait box according to various aspects of the present disclosure.

FIG. 10 illustrates an embodiment of a removable bait cartridge in accordance with various aspects of the present disclosure.

FIG. 11 illustrates an embodiment of the removable bait cartridge in accordance with various aspects of the present disclosure.

FIG. 12 illustrates an embodiment of a liquid dispenser.

FIG. 13 illustrates an embodiment of the bait box according to various aspects of the present disclosure.

FIG. 14 illustrates an embodiment of a bait box in a closed state in accordance with various aspects of the present disclosure.

FIG. 15 illustrates an embodiment of the bait box in an open state in accordance with various aspects of the present disclosure.

FIG. 16 illustrates an embodiment of the bait box in an open state in accordance with various aspects of the present disclosure.

FIG. 17 illustrates an embodiment of the bait box according to various aspects of the present disclosure.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific aspects, and implementations consistent with principles of this disclosure. These implementations are described in sufficient detail to enable those skilled in the art to practice the disclosure and it is to be understood that other implementations may be utilized and that structural changes and/or substitutions of various elements may be made without departing from the scope and spirit of this disclosure. The following detailed description is, therefore, not to be construed in a limited sense.

It is noted that description herein is not intended as an extensive overview, and as such, concepts may be simplified in the interests of clarity and brevity.

All documents mentioned in this application are hereby incorporated by reference in their entirety. Any process described in this application may be performed in any order and may omit any of the steps in the process. Processes may also be combined with other processes or steps of other processes.

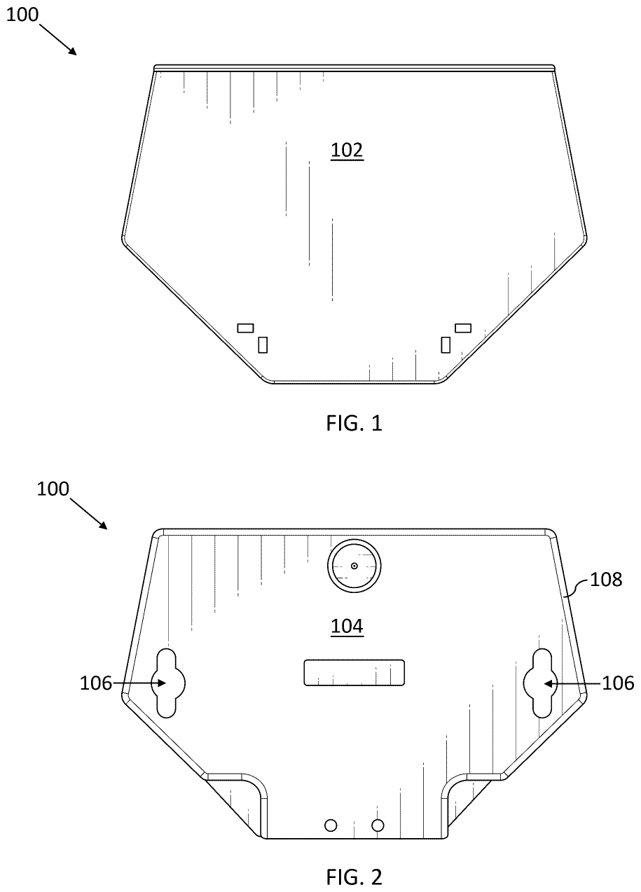

The present disclosure relates to a bait box securing system, apparatus, and method for utilizing the same. Turning to FIGS. 1 and 2, the present disclosure may include a bait box 100. The bait box 100 may be formed of injection molded plastic. In an embodiment, the bait box 100 includes a lid 102, a base 104, one or more locking features (obscured), at least one entrance aperture (obscured), and one or more securing interfaces 106.

The bait box 100 may be constructed from a variety of materials including cardboard, metals, plastics, or any other suitable material known to those of skill in the art. As a nonlimiting example, the bait box 100 may be constructed from aluminum, polyethylene, or polypropylene. In a preferred embodiment, the bait box 100 is constructed from a material optimized for handling outdoor conditions (e.g., wide temperature fluctuations, moisture, and ultraviolet exposure) without significantly degrading in structural integrity.

As mentioned above, the bait box 100 may include the lid 102. In an embodiment, the lid 102 may be hingedly attached to the base 104 (discussed in further detail below). The lid 102 may permit a user access to an interior of the bait box 100. As a nonlimiting example, a perimeter of the lid 102 may slightly overlap a perimeter of the base 104 so as to prevent liquids from entering an interior of the bait box 100.

As the bait box 100 may include poison within its interior, it may be desirable to have the lid 102 securely attach to the base 104 so as to prevent unwanted access. Thus, in some embodiments, the one or more locking features may prevent unwanted and/or inadvertent access to the interior of the bait box 100.

In one embodiment, the one or more locking features may secure the lid 102 to the base 104. In an embodiment, the one or more locking features may comprise a lock, such as a key lock, magnetic lock, code lock, or any other lock. It is contemplated that a portion of the lock that permits the engagement/disengagement of the lid 102 may be accessible from the exterior of the bait box 100.

As a nonlimiting example where the one or more locking features comprise a lock, the lock, when engaged (i.e., locked), may prevent access to the interior of the bait box 100. However, when disengaged (i.e., unlocked), may permit the lid 102 to be removed and/or hingedly rotated relative to the bait box 100 to permit access to the interior. It is contemplated that this access may permit a user to clean out the interior of the bait box 100 and/or replace bait contained within the bait box 100.

Furthermore, the base 104 may include a sidewall 108. The sidewall 108 may be disposed along a perimeter of the base 104 and may define at least one entrance aperture (obscured) configured to permit entry to pests (e.g., mice, rats, silverfish, cockroaches, etc.). The at least one entrance aperture may be a variety of shapes including circular, square, triangular, or any other suitable shape. It is contemplated that specific shapes may be used to selectively accommodate the pest entering the bait box 100. In an embodiment, the entrance aperture may include a door hingedly attached to the sidewall and covering the at least one entrance aperture. Such a door may be configured to allow one-way entry into the bait box 100, thereby trapping the pest inside the bait box 100.

In an embodiment, the base 104 may include one or more securing interfaces 106. The one or more securing interfaces 106 may allow a user to securely fix the bait box 100 to any surface including one or more securing members (e.g., screws, bolts, etc.). As a nonlimiting example, the one or more securing interfaces 106 may be disposed on a bottom surface of the base 104 as illustrated in FIG. 2.

The one or more securing interfaces 106 may include at least one cutout intersecting the bottom surface of the base 104. Such a cutout may be in the form of one or more of several shapes including, without limitation, a stadium having a circle intersecting an approximate center of the stadium (as shown in FIG. 2), a circle having a half stadium extending from the circle, etc. However, any suitable shape having a wide-width portion, and a narrow-width portion may be used.

As previously discussed, the one or more securing interfaces 106 may interface with one or more securing members. In an embodiment, the one or more securing members include bolts, one or more screws 436 (described in more detail below), or another suitable fastener. The one or more securing members may be secured to any surface to which a user desires to secure the bait box 100.

The one or more securing members may be secured at a set interface distance. In an embodiment, the set interface distance is a distance measured between each of the one or more securing members. Such distance may approximately equal the distance between an approximate center of each of the one or more securing interfaces 106. In such an embodiment, once the one or more securing members are secure, the one or more securing interfaces 106 may be positioned over the one or more securing members such that a top portion of the one or more securing members pass through the opening of the one or more securing interfaces 106. The bait box 100 may then be moved to cause the narrower shaft of the one or more securing members to pass into the narrower portion of the one or more securing interfaces 106 (e.g., the stadium portion).

As exemplified in the preceding paragraphs, the one or more securing interfaces 106 may include a portion that is slightly wider than the top portion of the one or more securing members, and a portion that is narrower than the top portion of the one or more securing members, but slightly wider than the shaft portion of the one or more securing members. As such, the bait box 100 may be removably secured to a surface via the one or more securing members.

The one or more securing interfaces 106 may comprise one or more magnets configured to secure the bait box 100 to any suitable ferromagnetic surface. In such an embodiment, the one or more magnets may be encased within the material of the base 104, attached to an external surface of the base 104, or otherwise suitably secured to the bait box 100. In another embodiment, magnets are secured within an interior of the bait box 100 as may be defined by the sidewall 108.

The bait box 100 may be configured to interface with a weighted base 432 (described in more detail below). For example, such a weighted base 432 may include members containing concrete or other heavy substances. The weighted base 432 may comprise a shape approximately matching that of the base 104. In an embodiment, the weighted base 432 may include one or more securing members (e.g., the one or more screws 436) configured to interface with the one or more securing interfaces 106. Accordingly, where a suitable surface is otherwise unavailable to secure the bait box 100 to, the bait box 100 may be prevented from undergoing undesired movement by adding weight to the bait box 100. The thickness and/or material of the weighted base 432 may be adjusted depending on the desired amount of weight to be attached to the bait box 100.

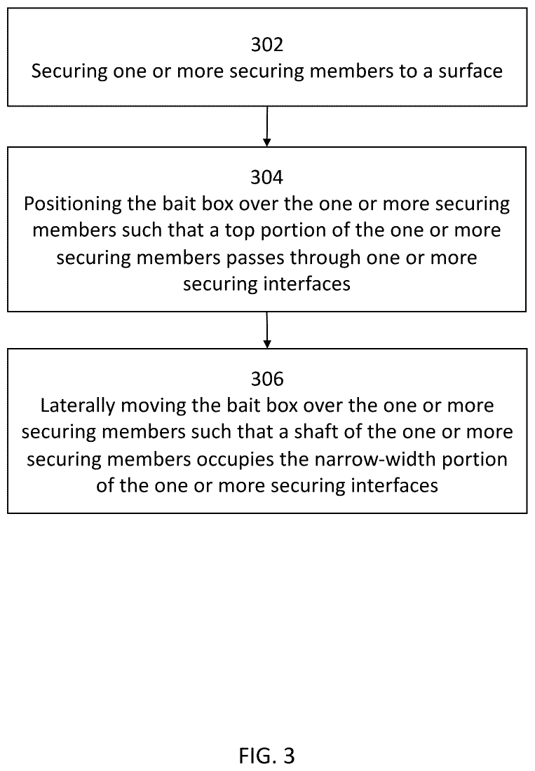

Using the various features described herein, a user may secure the bait box 100 using a method 300 which may include the steps illustrated in FIG. 3. Such a method 300 may include step 302 in which a user may secure one or more securing members to a surface. As a nonlimiting example, a user may attach the one or more securing members to the façade of a building. In an embodiment a user may use bolts or screws and attach said fasteners to the surface (e.g., a building façade) using means known to those of skill in the art. As discussed above, the user may attach the one or more securing members a distance apart from one another matching the distance between an approximate center of the one or more securing interfaces 106.

At step 304, the user may then position the bait box 100 over the one or more securing members such that a top portion of the one or more securing members passes through one or more securing interfaces 106. In an embodiment, the width of the top portion of the one or more securing members is configured to only pass through a wide portion of the one or more securing interfaces 106, allowing the one or more securing interfaces 106 to be positioned over the one or more securing members. In an embodiment, the one or more securing interfaces 106 may enable the bait box 100 to be secured to surfaces such as, but not limited to, concrete, brick, etc. In another embodiment, the bait box 100 may also be secured to external structures, including, the weighted base 432 (described in more detail below), buildings, etc.

Next, at step 306, the user may then take advantage of a shaft portion of the one or more securing members which are configured to pass into the narrow portion of the one or more securing interfaces 106, thereby preventing the bait box 100 from being pulled away from the surface the one or more securing members are attached to. Thus, at step 306, the user may laterally move the bait box 100 over the one or more securing members such that a shaft of the one or more securing members occupies the narrow-width portion of the one or more securing interfaces 106 and prevents the bait box 100 from being easily removed.

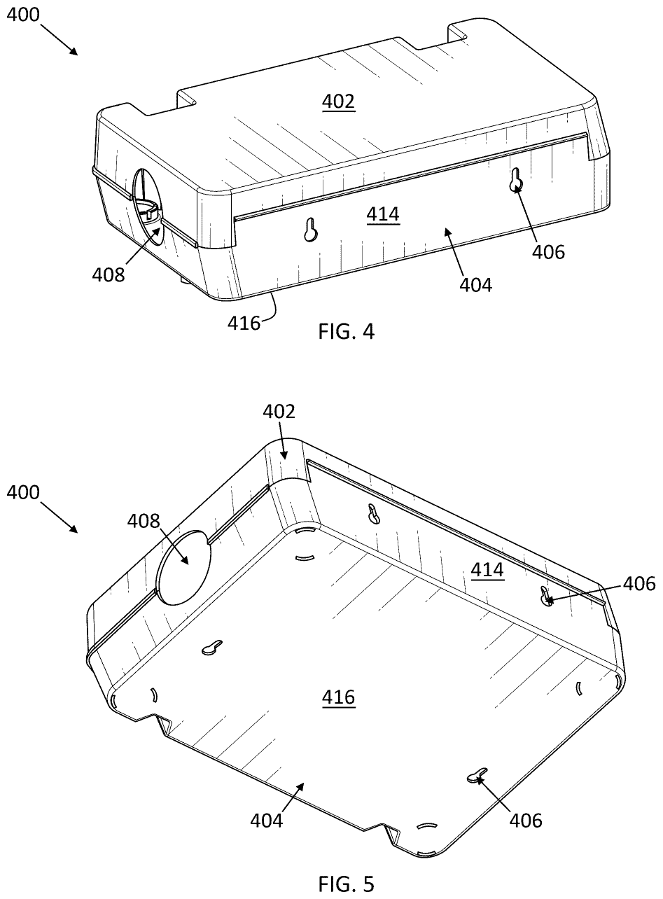

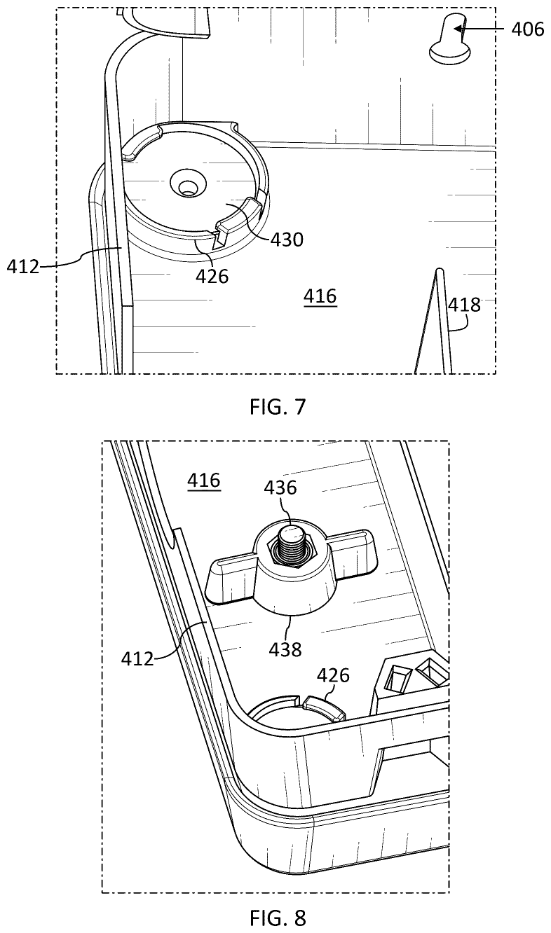

FIGS. 4-8 illustrate another embodiment of a bait box 400. In an embodiment, the bait box 400 comprises a lid 402, a base 404, one or more securing interfaces 406, at least one entrance aperture 408, and one or more locking features 410. The one or more locking features 410, the at least one entrance aperture 408, and the one or more securing interfaces 406 may comprise any of the characteristics described with reference to FIGS. 1-2. For example, the bait box 400 may comprise one or more securing interfaces 406 as discussed with reference to the one or more securing interfaces 106 described in FIGS. 1 and 2. Of course, other characteristics are contemplated and the aforementioned are provided as a nonlimiting example only.

Moreover, the base 404 may comprise a top 412, at least one sidewall 414, and a bottom 416, wherein the top 412 and bottom 416 are secured to one another via the at least one sidewall 414. The space disposed between the top 412, bottom 416, and the at least one sidewall 414 may define an interior of the bait box 400.

Further, the one or more securing interfaces 406 may be disposed on the bottom 416 of the base 404 and/or the at least one sidewall 414 to secure with one or more securing members. The one or more securing interfaces 406 may include at least one cutout intersecting the at least one sidewall 414 and/or the bottom 416 of the base 404 and extending into the interior of the bait box 400. Such cutout may be in the form of one or more of several shapes including, without limitation, a stadium having a circle intersecting an approximate center of the stadium, or a circle having a half stadium extending from the circle. However, any suitable shape having a wide-width portion, and a narrow-width portion may be used.

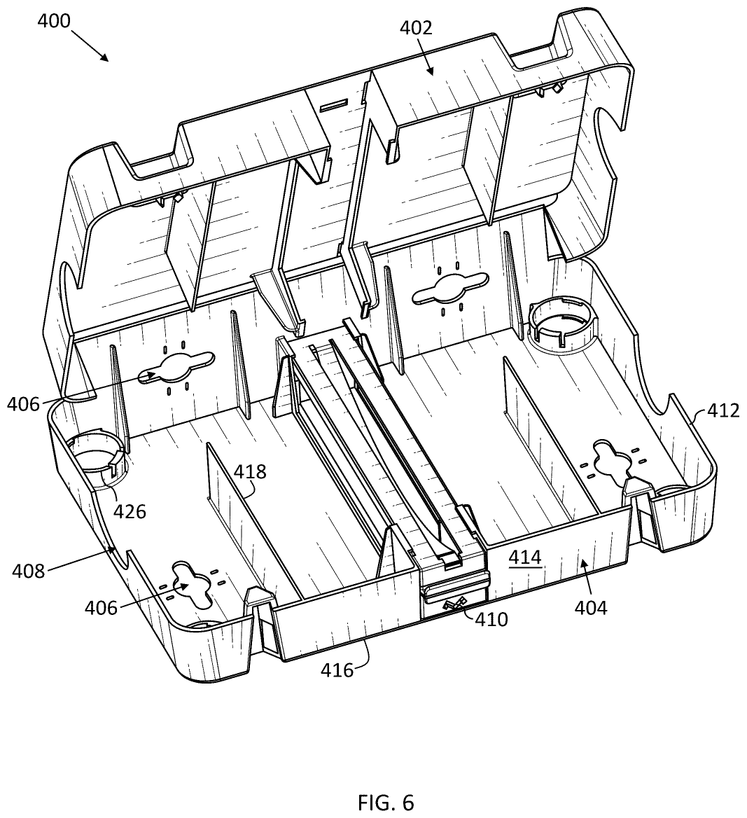

As illustrated in FIG. 6, the lid 402 may be hingedly connected to the base 404 to permit access to the interior of the bait box 400. As a nonlimiting example, a portion of the top 412 of the bait box 400 may be configured to secure to the lid 402. When closed, as illustrated in FIGS. 4 and 5, the lid 402 and the top 412 may form a continuous surface of the bait box 400. However, when in an open state, as illustrated in FIG. 6, the lid 402 may be disengaged from the top 412 and hingedly rotated away from the base 404 to reveal the interior of the bait box 400.

The interior of the bait box 400 may, in accordance with one embodiment, house a bait station for rodents or other pests. In one embodiment, the bait station may comprise at least one bait cartridge 420 (described in more detail below). The bait cartridge 420 may comprise any bait 442 that may be desired, such as poison or other traps.

Further, the interior of the bait box 400 may comprise internal walls 418 disposed between the entrance aperture 408 and the bait cartridge 420. The use of internal walls 418 within the bait box 400 may prevent external access to the bait cartridge 420. Further, the use of the bait cartridge 420 may ensure that the bait 442 is correctly positioned within the interior of the bait box 400. This may prevent inadvertent contact with the bait 442, reducing harm that may come with undesired contact with the bait 442. For example, it may prevent children or pets from accessing the bait 442.

In one embodiment, the bait cartridge 420 may be accessible without accessing the interior of the bait box 400. For example, the bait cartridge 420 may removably secure to the bait box 400. In one embodiment, the bait cartridge 420 may comprise a locking mechanism 440 configured to fasten the bait cartridge 420 to the bait box 400. For example, the bait cartridge 420 may be secured to the bait box 400 through the use of a key lock, magnetic lock, code lock, friction fit, or any other means for securing that may be desired.

Yet further, the bait box 400 may be further comprised of one or more magnet wells 426, the one or more securing interfaces 406, and the weighted base 432 (described in more detail below).

In an embodiment, the one or more magnet wells 426 may be configured to house at least one magnet 430. In such an embodiment, the at least one magnet 430 may allow for the bait box 400 to reversibly adhere to a ferromagnetic surface. As a nonlimiting example, the one or more magnet wells 426 may be comprised of four magnet wells, wherein each of the four magnet wells is located in a corner of the base 404.

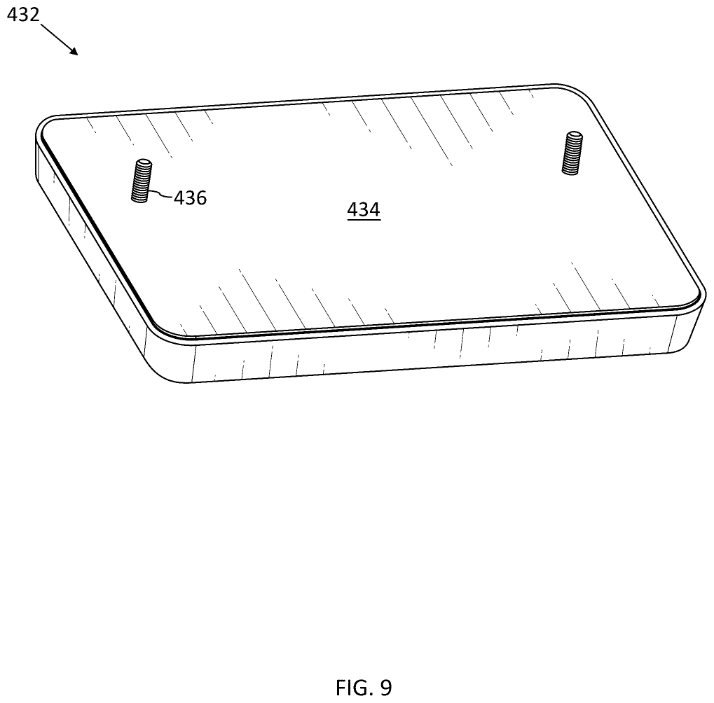

As previously mentioned, the bait box 400 may be further comprised of the one or more securing interfaces 406 and the weighted base 432. As illustrated in FIG. 9, the weighted base 432 may be comprised of a concrete foundation 434 and one or more screws 436. In an embodiment, the one or more screws 436 may be permanently affixed to the concrete foundation 434, such that said screws 436 may not be removed from the foundation 434.

Moreover, the one or more screws 436 may traverse the one or more securing interfaces 406 such that said screws 436 may enter an interior of the bait box 400. Furthermore, as shown in FIG. 8, upon the one or more screws 436 traversing the one or more securing interfaces 406, one or more wingnuts 438 may be used to secure the bait box 400 to the weighted base 432. As a nonlimiting example, the weighted base 432 may prevent the bait box 400 from being inadvertently moved.

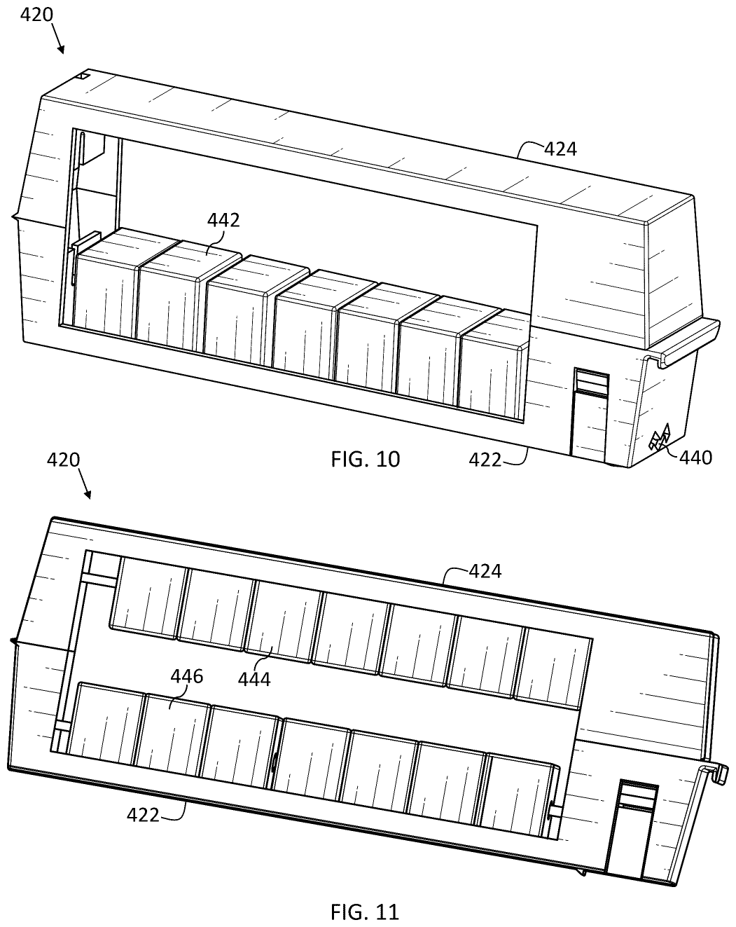

In the embodiment illustrated in FIG. 10, the bait cartridge 402 may comprise a base 422 and a crossbar 424 for housing the bait 442 extending therefrom. The base 422 may be configured to secure to an aperture within the sidewall 414 of the bait box 400 and may comprise the locking mechanism 440. Indeed, the bait cartridge 420 may be secured to the bait box 400 such that it cannot be removed without unlocking the bait cartridge 420 from the sidewall 414. By preventing the removal of the bait cartridge 420 without unlocking, the bait box 400 may prevent undesired contact with the bait 442.

Upon unlocking the bait cartridge 420 from the bait box 400, the bait 442 within the bait cartridge 420 may be removed and replaced. This may permit the bait 442 to be changed and/or refilled without unlocking and removing the bait box 400 from the surface it is secured to. Further, the bait cartridge 420 may be removed and replaced without unlocking the one or more locking features 410 that secure the lid 402 to the base 404.

In some embodiments, the one or more securing interfaces 406, the one or more locking features 410, and the bait cartridge 420 may permit the bait box 400 to be relocated without accessing its interior. Specifically, the one or more securing interfaces 406 may be disengaged with the one or more securing members without removing and/or accessing the bait 442 in the interior of the bait box 400. Likewise, the bait box 400 may be secured to a surface without accessing the interior of the bait box 400, which reduces contact with the bait 442 secured therein.

In one embodiment, the base 422 may be configured to receive a new crossbar 424 for housing the bait 442 comprising a new bait. In another nonlimiting example, the crossbar 424 for housing the bait 442 may be configured to removably secure to the bait 442, such that the bait 442 may be interchanged. In such an embodiment, the bait cartridge 420 may require loading, such that the crossbar 424 for housing the bait 442 may receive a replacement bait and the previous bait may be removed.

In some embodiments the bait cartridge 420 may be preloaded, such that the crossbar 424 comprises bait 442 and may be interchanged with an existing bait cartridge 420. It is contemplated that preloading the bait cartridge 420 may permit a safe, quick loading of the bait cartridge 420 into the bait box 400.

The bait cartridge 420 may include a plurality of sections each configured to contain a specific type of material/bait. As a nonlimiting example, the bait cartridge 420 may include two portions, one configured to hold solid bait, and the other configured to hold liquid bait. As such, a user may configure the bait cartridge 420 to deliver a single or customized combination of baits to pests when the bait cartridge 420 is installed.

Moreover, as illustrated in FIG. 11, the bait cartridge 420 may hold two solid baits. Indeed, a first solid bait 444 may be suspended from the crossbar 424 via a wire, while a second solid bait 446 may be coupled to the base 422 via a wire or metal rod. Thus, the bait cartridge 420 may employ a double decker feature, allowing multiple baits to be deployed simultaneously.

Said solid baits 444/446 may include both anticoagulant baits and non-anticoagulant baits. For instance, the anti-coagulant baits may include brodifacoum, diphacinone, warfarin, and the like. Moreover, the non-anti-coagulant baits may include bromethalin, cholecalciferol, zinc phosphide, and the like. These baits may be affixed to the base 422 and/or suspended from the crossbar 424 via a wire.

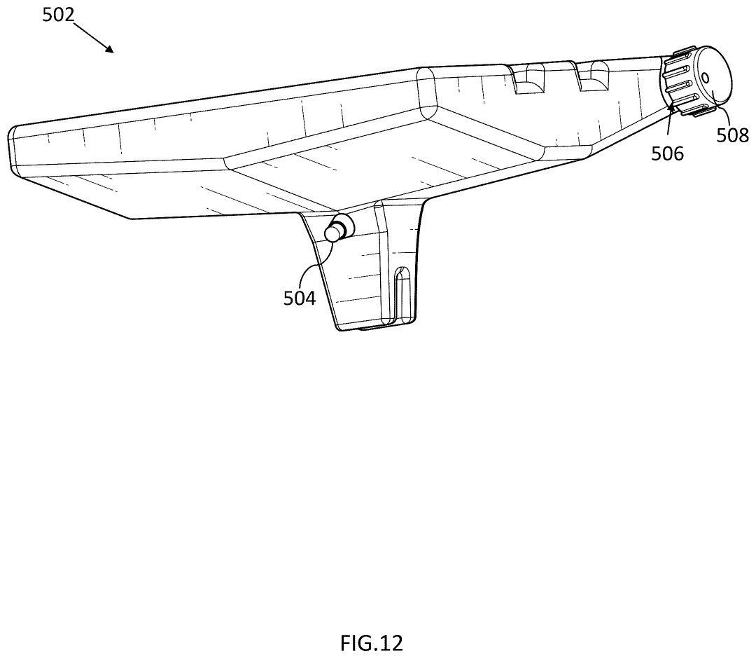

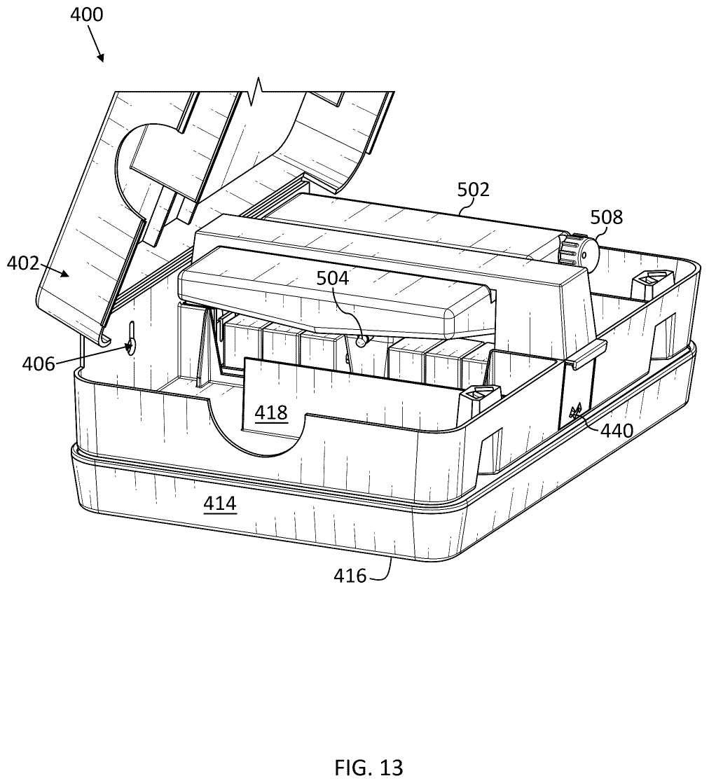

Referring to FIGS. 12 and 13, the bait box 400 may be further comprised of a liquid dispenser 502. In an embodiment, the liquid dispenser may be comprised of one or more liquid dispensing tubes 504 and/or a fill aperture 506. In an embodiment, the liquid dispenser 502 may be reversibly coupled to the crossbar 424.

To illustrate, the liquid dispenser 502 may be filled with a liquid poison via the fill aperture 506. In an embodiment, the fill aperture 506 may be covered with a cap 508, such that the liquid poison does not inadvertently escape the liquid dispenser 502. Moreover, the one or more dispensing tubes 504 may dispense the liquid poison residing within the liquid dispenser 502. As a nonlimiting example, the one or more dispensing tubes 504 may function similarly to a sipper water bottle. To explain, the one or more dispensing tubes 504 may include a ball bearing (not depicted) that forms a vacuum with said tubes 504 when not being used, thus proscribing the flow of liquid poison from the liquid dispenser 502 to an external environment. However, when an animal actuates the ball bearing via sipping on the one or more dispensing tubes 504, liquid poison may freely flow from the liquid dispenser 502, through the one or more dispensing tubes 504, and into the mouth of said animal.

Additionally, the liquid dispenser 502 may reversibly couple with the crossbar 424 of the at least one bait cartridge 420. In such an embodiment, the bait box 400 may employ both a food poison and a liquid poison, wherein the food poison is deployed by the base 422 of the cartridge, while the crossbar 424 simultaneously attaches to the liquid dispenser 502 to dispense the liquid poison.

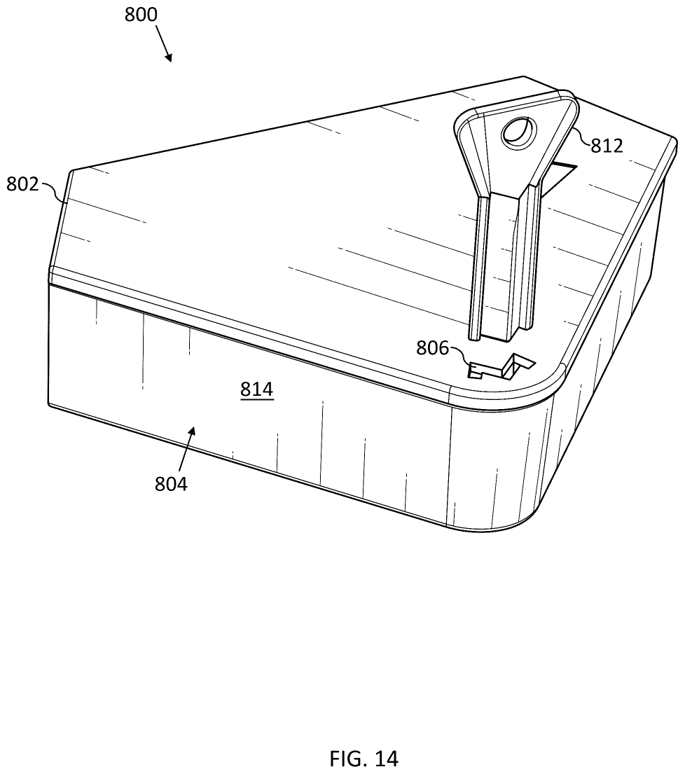

Moving on to FIG. 14, an alternative bait box 800 may be illustrated. The bait box 800 may utilize the same components and features as described in relation to bait boxes 100 and 400 and may also possess the features and capabilities as described below. The bait box 800 may be constructed from a variety of materials including cardboard, metals, plastics, or any other suitable material known to those of skill in the art. As a nonlimiting example, the bait box 800 may be constructed from aluminum, polyethylene, or polypropylene. In a preferred embodiment, the bait box 800 is constructed from a material optimized for handling outdoor conditions (e.g., wide temperature fluctuations, moisture, and ultraviolet exposure) without significantly degrading in structural integrity.

The bait box 800 may include a lid 802. In an embodiment, the lid 802 is hingedly attached to the base 804, which is discussed in further detail below. The lid 802 may permit a user access to an interior of the bait box 800. As a nonlimiting example, a perimeter of the lid 802 may slightly overlap a perimeter of the base 804 so as to prevent liquids from entering the bait box 800.

Furthermore, the bait box 800 may be in at least one of an open state and a closed state. In the closed state, the lid 802 may be secured to the base 804 by one or more locking features 806 (described in further detail below). Whereas, in the open state, the lid 802 may not be secured to the base 804, such that the interior of the bait box 800 is in fluid communication with an external environment.

In one embodiment, the bait box 800 may include one or more locking features 806. In such an embodiment, the one or more locking features 806 may secure the lid 802 to the base 804. In an embodiment, the one or more locking features 804 may comprise a lock, such as a key lock, magnetic lock, code lock, or any other lock. It is contemplated that a portion of the lock that permits the engagement/disengagement of the lid 802 may be accessible from the exterior of the bait box 800. The one or more locking features 806 may be configured to interface with a key 812.

Thus, when the lock is engaged, the bait box 800 may correspondingly be in the closed state. However, when the lock is disengaged, the lid 802 may be removed and/or hingedly rotated relative to the base 804 to transition the bait box 800 from the closed to open state. It is contemplated that this access may permit a user to clean out the interior of the bait box 800 and/or replace bait contained within the bait box 800.

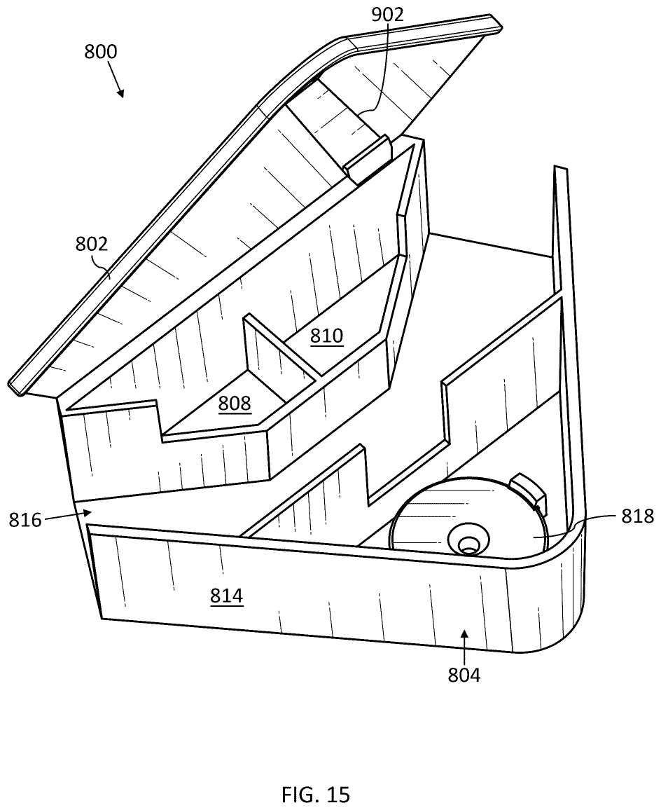

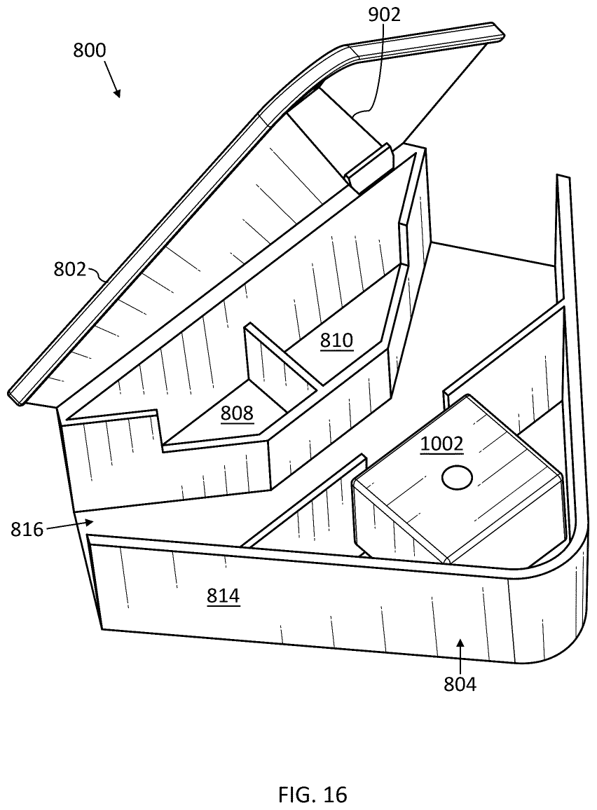

In an embodiment, the key 812 may interface with a catch 902 (depicted in FIGS. 15 and 16) configured to selectively secure the lid 802 to the base 804. In such an embodiment, the key 812 may be uniquely shaped so as to prevent undesired access to the bait box 800. The key 812, once inserted into the one or more locking features 806 may enable a user to apply leverage to the catch 902 to disengage it from the base 804, allowing the lid 802 to be raised.

Furthermore, the base 804 may include a sidewall 814. The sidewall 814 may be disposed along a perimeter of the bottom surface of the base 804 and may define at least one entrance aperture 816 configured to permit entry to pests. The at least one entrance aperture 816 may be a variety of shapes including circular, square, triangular, or any other suitable shape. It is contemplated that specific shapes may be used to selectively accommodate the animal entering the bait box 800. In an embodiment, the entrance aperture 816 may include a door hingedly attached to the sidewall 814 and covering the at least one entrance aperture 816. Such a door may be configured to allow one-way entry into the bait box 800, thereby trapping the animal inside of said box 800.

In an embodiment, the base 804 includes one or more securing interfaces (obscured) as described above regarding bait boxes 100 and 400. The one or more securing interfaces may allow a user to securely fix the bait box 800 to any surface including one or more securing members. As a nonlimiting example, the one or more securing interfaces may be disposed on a bottom surface of the base 804.

The bait box 800 may include several compartments within an interior of the bait box 800. As a nonlimiting example, and as illustrated in FIG. 15, the bait box 800 may include compartments 808/810 configured to hold bait. Such bait may be any suitable bait as contemplated by those of skill in the art. To illustrate, the first compartment 808 may hold a first type of poison, while the second compartment 810 houses a second type of poison. Yet further, the compartments 808/810, in conjunction with a bait block 1002, may enable three types of poison to be employed by the bait box 800 simultaneously. In yet another nonlimiting example, compartments 808/810 may secure specialized bait to attract a variety of pests. Said specialized baits may include, but are not limited to, gel, Niban granular bait, etc.

Thus, the bait box 800 disclosed herein may accommodate and deploy three distinct poisons within a single unit. Such a multi-poison configuration enables comprehensive pest control. For example, the bait box 800 may simultaneously target multiple pests at once. Specifically, the bait box 800 may be configured to attract mice, cockroaches, waterbugs, silverfish, ants, spiders, centipedes, and the like. This versatility not only enhances efficacy but also reduces the need for multiple discrete pest control devices, offering both functional and economic benefits to the end user.

The bait box 800 may include a compartment configured to house a magnet 818. The magnet 818 may be utilized to secure the bait box 800 to a ferromagnetic surface, or to removably secure bait within the bait box 800.

As shown in FIG. 16, the magnet 818 may be used to removably secure the bait block 1002 within the bait box 800. While a bait block 1002 is illustrated in FIG. 15, the magnet 818 may be used to secure any suitable item within the bait box 800 as may be contemplated by those of skill in the art. Moreover, the magnet 818 may enable the bait box 800 to reversibly couple to any suitable ferromagnetic surface.

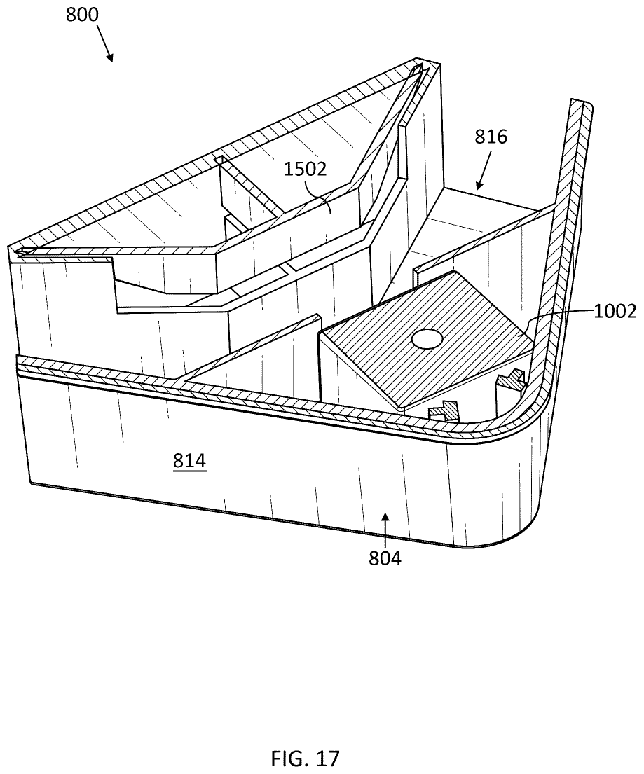

Turning to FIG. 17, the bait box 800 may be further comprised of a lip 1502. In an embodiment, the lip 1502 may be disposed across the compartments 808/810 configured to hold bait. In such an embodiment, the lip 1502 may be configured to secure bait disposed within said compartments 808/810.

Various elements, which are described herein in the context of one or more embodiments, may be provided separately or in any suitable subcombination. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It will be further understood that various changes in the details, materials, and arrangements of the parts that have been described and illustrated herein may be made by those skilled in the art without departing from the scope of the following claims.

All references, patents and patent applications and publications that are cited or referred to in this application are incorporated in their entirety herein by reference. Finally, other implementations of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A secure bait box for pest removal comprising:
a base including:
a bottom surface,
a sidewall disposed along, and extending from, a perimeter of the bottom surface,
an interior space defined by the bottom surface and the sidewall;
an entrance aperture for entry to the interior space disposed within the sidewall;
a lid affixed to the sidewall;
one or more locks disposed on the base for reversibly securing the lid to the base; and
a bait cartridge reversibly coupled to the base, the bait cartridge including:
a cartridge base able to secure a first bait, and
a crossbar coupled to the cartridge base, the crossbar able to secure a second bait.

2. The secure bait box of claim 1, wherein the first bait is a solid bait.

3. The secure bait box of claim 2, wherein the second bait is a solid bait.

4. The secure bait box of claim 2, further comprising:
a liquid dispenser including:
one or more liquid dispensing tubes.

5. The secure bait box of claim 4, wherein the second bait is a liquid bait contained within the liquid dispenser, and the liquid dispenser is reversibly coupled to the crossbar.

6. The secure bait box of claim 1, wherein the lid is hingedly affixed to the base.

7. The secure bait box of claim 1, further comprising:
one or more securing interfaces integrated into the base.

8. The secure bait box of claim 7, wherein the one or more securing interfaces interface with one or more securing members to secure the base to an external surface.

9. The secure bait box of claim 7, wherein the one or more securing interfaces are integrated into the sidewall.

10. The secure bait box of claim 7, wherein the one or more securing interfaces are integrated into the bottom surface.

11. The secure bait box of claim 7, wherein the one or more securing interfaces are integrated into both the sidewall and the bottom surface.

12. The secure bait box of claim 1, wherein the lid and the base are constructed from injection-molded plastic.

13. A secure bait box for pest removal comprising:
a base including:
a bottom surface,
a sidewall disposed along, and extending from, a perimeter of the bottom surface,
an interior space defined by the bottom surface and the sidewall, the interior space including:
a first compartment able to hold a first bait,
a second compartment able to hold a second bait, and
a third compartment able to hold a third bait;
an entrance aperture for entry into the interior space disposed within the sidewall;
a lid affixed to the sidewall; and
one or more locks disposed on the base for reversibly securing the lid to the base.

14. The secure bait box of claim 13, further comprising:
one or more securing interfaces integrated into the sidewall.

15. The secure bait box of claim 13, further comprising:
one or more securing interfaces integrated into the bottom surface.

16. The secure bait box of claim 13, further comprising:
one or more securing interfaces integrated into both the sidewall and the bottom surface.

17. The secure bait box of claim 13, wherein the third compartment includes at least one magnet.

18. The secure bait box of claim 13, wherein the lid is hingedly affixed to the base.

19. The secure bait box of claim 13, wherein the lid and the base are constructed from injection-molded plastic.
